(19) United States
(12) Patent Application Publication
(10) Pub. No.: US 2019/0217264 A1
(43) Pub. Date: Jul. 18, 2019

(54) PERSONAL WATER ENHANCEMENT DEVICE

(71) Applicants: William Burgess, Rockville, MD (US); Daniel Evans, Gaithersburg, MD (US); Cormac Keating, Potomac, MD (US); Simon Kim, Potomac, MD (US); Alexander Lacaze, Potomac, MD (US); Daniel Lacaze, Potomac, MD (US); Kerry McKeon, Potomac, MD (US); Bryce West, Rockville, MD (US)

(72) Inventors: William Burgess, Rockville, MD (US); Daniel Evans, Gaithersburg, MD (US); Cormac Keating, Potomac, MD (US); Simon Kim, Potomac, MD (US); Alexander Lacaze, Potomac, MD (US); Daniel Lacaze, Potomac, MD (US); Kerry McKeon, Potomac, MD (US); Bryce West, Rockville, MD (US)

(21) Appl. No.: 15/872,144

(22) Filed: Jan. 16, 2018

(51) Int. Cl. B01F 15/04; C02F 1/00; B01D 61/08; C02F 1/52; C02F 1/44; B01D 61/12

(52) U.S. Cl. CPC B01F 15/0416; C02F 1/003; B01F 15/0429; B01D 61/08; C02F 1/5245; B01D 2313/18; B01D 61/12; C02F 2201/005; B01D 2313/243; B01D 2313/12; C02F 1/441

(57) ABSTRACT

The personal water enhancement device disclosed herein is designed for removing particulates and impurities from a volume of water and then adding a preferred combination of vitamins and minerals to such volume of water. In a preferred embodiment, the device may comprise a water purifier and filter, a user interface, a database of water formulations, a container for storing salts, and a mechanism for dispensing salts into water. Such a device may allow a user to add a pre-set or customized concentration of various salts and minerals to said volume of water as per their unique needs, and may further reduce both the environmental burden of plastic bottle production and the financial burden of bottled water consumption.

### PRIORITY NOTICE

The present application makes no claims of priority under 35 U.S.C. § 119(e) to any U.S. Provisional Patent Applications.

### CROSS REFERENCE TO RELATED PATENT APPLICATIONS

The present application makes no reference to any other related filed patent applications.

### STATEMENT REGARDING FEDERAL SPONSORSHIP

No part of this invention was a result of any federally sponsored research.

### TECHNICAL FIELD OF THE INVENTION

The present invention relates in general to water enhancement devices and, more specifically, to a personal water enhancement device for removing particulates and impurities from a volume of water and then adding a preferred combination of vitamins and minerals to such volume of water.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

The cost of drinking water varies significantly depending on how it is purchased. Bottled water can cost over $10 US per gallon (2017 prices), while the same amount of water from the tap can cost less than $0.01.

Most water currently consumed contains salts. Several groups of people need different custom water formulas, whether for medical reasons, for sports dietary reasons, or for taste reasons. Different industries are built around satisfying the various needs of these different segments of the population.

For example, many consumers with medical conditions need certain salts and minerals in exact measures. Consumers with medical conditions, such as kidney disease, diabetes, gout, and cardiac issues may benefit from this system in the following ways. First, this system can eliminate all potassium as well as regulate the calcium in water to help contain kidney disease. Second, this system can alkalize water, which can help consumers prevent or address gout. Third, this system can regulate the magnesium, potassium, and calcium in water to help heart function. Another consumer group that would benefit from this proposed system is athletes who would require electrolytes as they are depleted during exercise. In addition to providing benefits to those with medical and metabolic requirements, this proposed system can be customized to deliver enhanced water according to lifestyle preferences. For example, a coffee aficionado may want to customize coffee by adding magnesium for sweetness, calcium for balance, or sodium to highlight acidity.

This device will help to customize water depending on needs or preferences. Presently, the cost of bottled water is higher than the cost of purchasing salts. Moreover, adding electrolytes through this proposed systems is much more cost effective and efficient than purchasing bottled water. The system is also significantly more environmentally friendly. Every year, Americans consume approximately 50 billion plastic water bottles. Only 23% of consumers recycle their plastic bottles. That means 38 billion water bottles are not recycled every year in America, which accumulates to more than $1 billion dollars in plastic. The energy cost to make plastic for water bottles every year is about 106 mega joules of energy. Over 17 million barrels of oil are used to produce the bottles made every year. This energy can be better used in other ways, and not producing so many plastic bottles would benefit the environment.

There is a need in the art for a personal water enhancement device for removing particulates and impurities from a volume of water and then adding a preferred combination of vitamins and minerals to such volume of water. Such a device may allow a user to add a pre-set or customized concentration of various salts and minerals to said volume of water as per their unique needs, and may further reduce both the environmental burden of plastic bottle production and the financial burden of bottled water consumption.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a personal water enhancement device.

It is an objective of the present invention to provide a personal water enhancement device for removing particulates and impurities from a volume of water and then adding a preferred combination of vitamins and minerals to such volume of water.

It is another objective of the present invention to provide a personal water enhancement device comprising a water purifier and filter.

It is another objective of the present invention to provide a personal water enhancement device comprising a user interface.

It is another objective of the present invention to provide a personal water enhancement device comprising a database of water formulations.

It is another objective of the present invention to provide a personal water enhancement device comprising a container for storing salts.

It is another objective of the present invention to provide a personal water enhancement device comprising a mechanism for dispensing salts into water.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an overview of the different subsystems of the present invention.

FIG. 2 illustrates an overview of the filtration process of the present invention.

FIG. 3 illustrates an overview of a user interface of the present invention.

FIG. 4 illustrates a salt dispensing process of the present invention.

FIG. 5 illustrates a salt dispensing process of the present invention.

FIG. 6 illustrates a salt dispensing process of the present invention.

FIG. 7 illustrates a method of mixture agitation of the present invention.

FIG. 8 illustrates a method of mixture agitation of the present invention.

FIG. 9 illustrates a method of mixture agitation of the present invention.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The present invention relates in general to water enhancement devices and, more specifically, to a personal water enhancement device for removing particulates and impurities from a volume of water and then adding a preferred combination of vitamins and minerals to such volume of water.

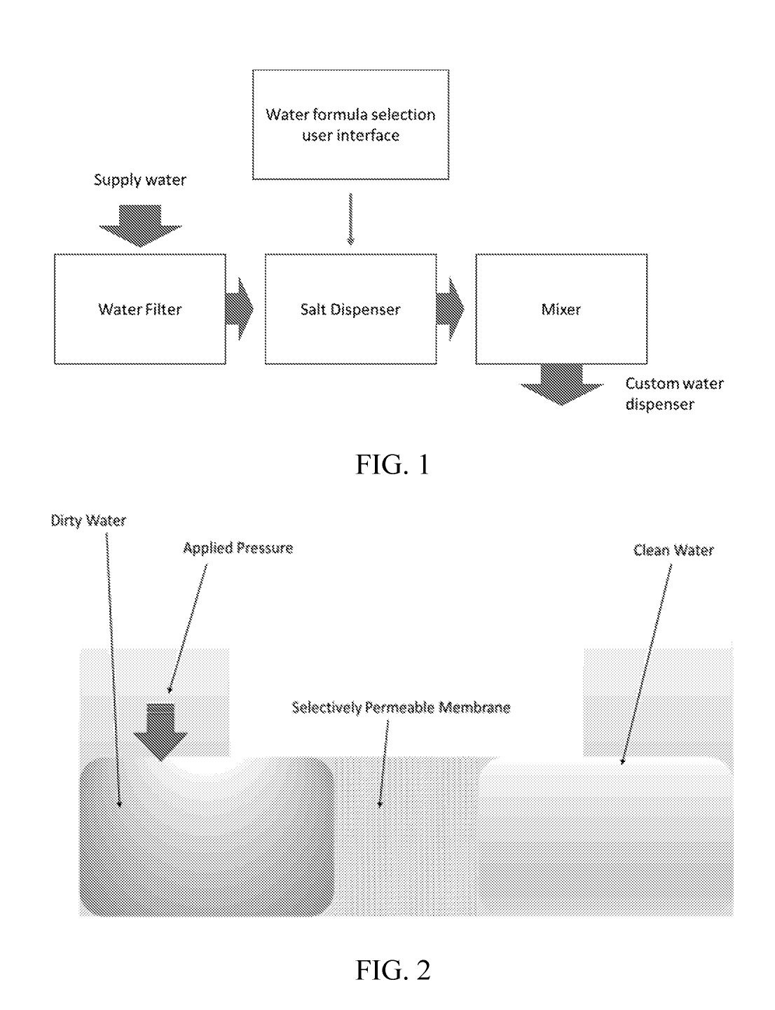

As illustrated in FIG. 1, the water enhancement device disclosed herein comprises four main components: a water filter, a user interface, a salt dispenser, and a mixer. The filter takes tap (or any other source of) water and extracts salts, impurities, and possibly bacteria and viruses. The user interface allows the user to select custom water for his/her use from a list of formulations stored on the device. The salt dispenser delivers the desired salts given the selected formula. A mixer makes sure that the salts are dissolved in the water. The system can be installed on a refrigerator or other appliances.

As illustrated in FIG. 2, the first stage of the invention purifies the water by using the reverse osmosis process (or other filtering process) where unpurified water will be pushed through a selectively permeable membrane. Regular water filters, such as the Brita Filter and Pur Filter, do not completely purify the water and only eliminate 10%-30% of chemicals. These filters also do not remove chlorine or some inorganics such as salts and arsenic. One of the reasons why these filters do not remove more from the solutions is that if more is removed, the taste becomes bland an unappetizing.

Because salts are added to the mixture as part of the system, the system can use filters that remove more impurities and dissolved elements without having to worry about the taste of the water as the taste may be enhanced for the particular application.

Once the water is completely purified, in further stages, this invention adds electrolytes, salts, minerals, and adjusts the PH to benefit the consumer. Because these salts are being added, the filter can actually remove larger amounts of salts in the original water. In contrast, water from a tap or refrigerator dispenser is not completely purified, contains impurities, and lacks electrolytes, vitamins, and minerals to preserve the taste.

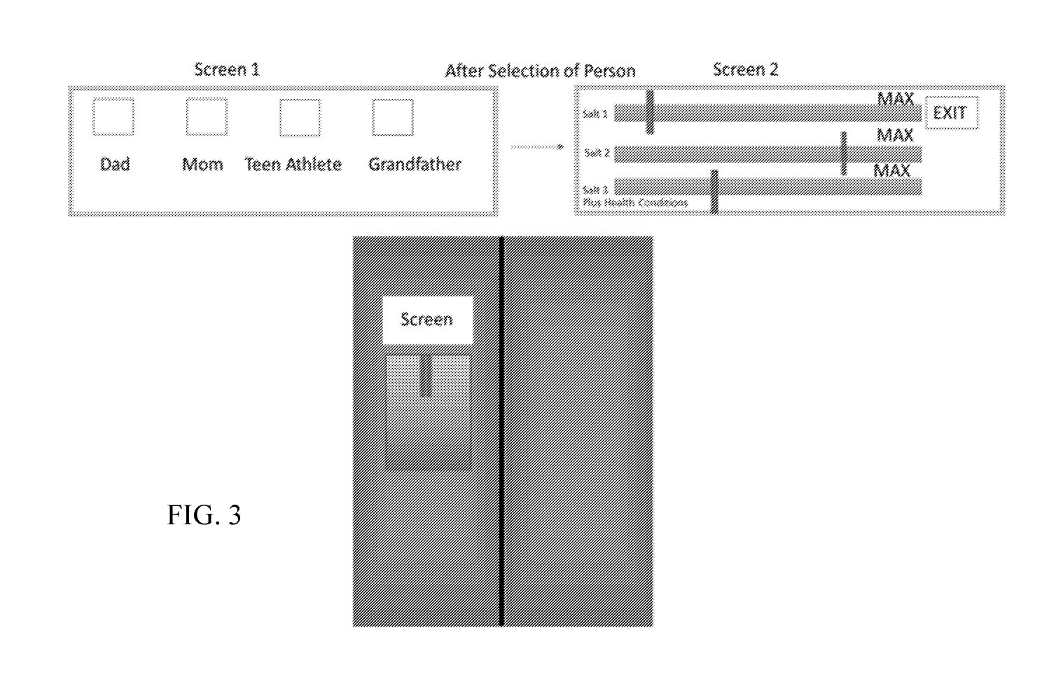

As illustrated in FIG. 3, the water selection mechanism involves an application based system on an electronic screen attached to the household item that is connected to the water dispenser. The application displays separate selectable custom names to specify what kind of water formula will be created. Once the custom name is selected, the amount of salts will be optimized for that selection. The application will let the user control the concentration and the amount of additives that are dispensed. After confirming the amount of salts desired or recommended, the water will dispense, and the application will restart. The application will also show the supply of available salts on a side bar.

The application may be modified to include a security mechanism for restricting access of unauthorized users from the system. The application may further record and display total salt consumption over time, and may automatically reorder salts as their reserve diminishes within the system.

The interface will allow the user to select the concentration of salts, the variety of salts, and keep track of the overall amounts of salts of each kind consumed by each user. The system may also interface with a device that can measure serum electrolyte concentration and hydration levels to determine the best water formulation profile. This measure may be direct or may just use the results of a lab performed test to automatically create the preferred formula.

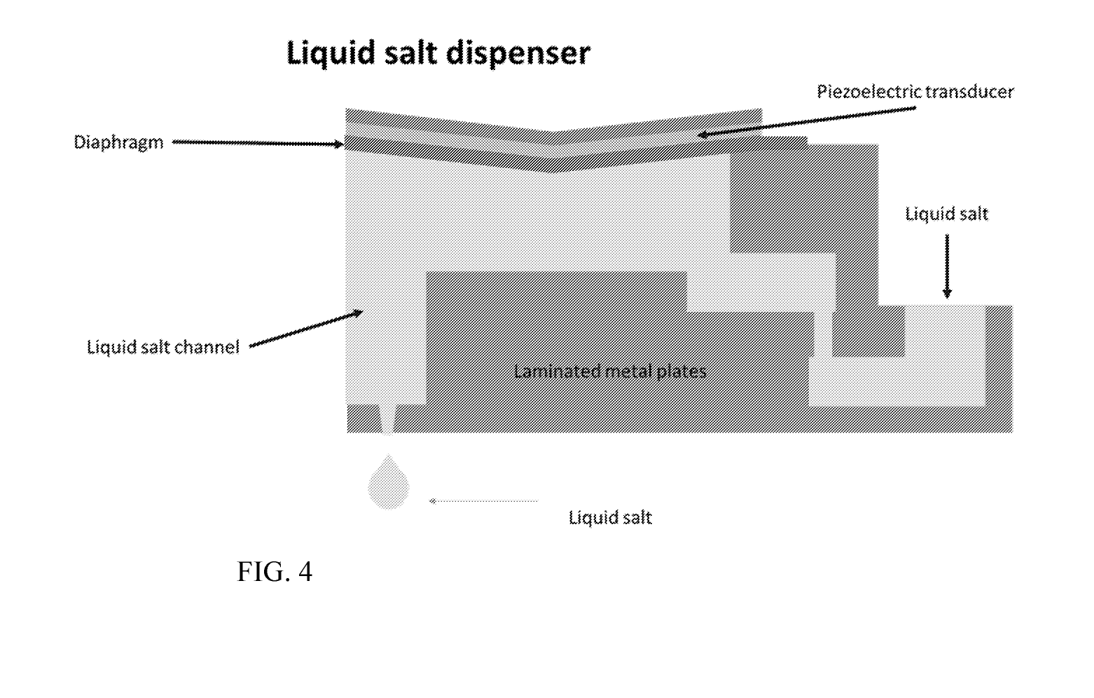

As illustrated in FIGS. 4 through 6, different methods can be used for delivering the salts into the water before dispensing to the user. These methods depend on whether the salts are in a liquid form or solid form. Three possible methods are described here, though others can also be used.

First, using a piezo to pump salty solution. Similar to an inkjet printer, a piezoelectric transducer can be used to pump the salty solution into the water mixture. FIG. 4 shows one such example. The number of cycles that the piezo is subjected determines the amount of salts being delivered.

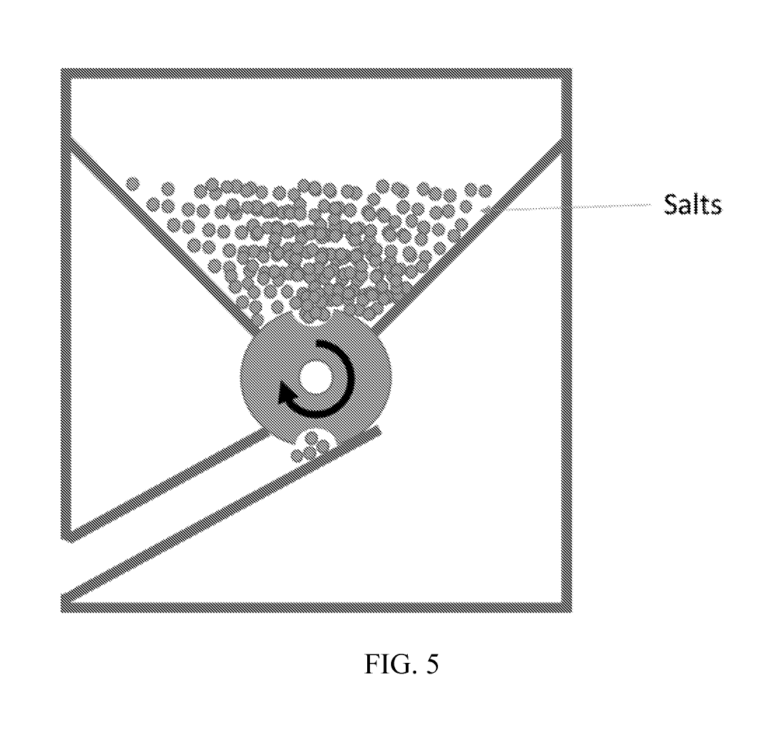

Second, using a rotating dispenser. Similar to a gumball machine or pill dispenser, salts in solid pellet form can be measured and dispensed with one of these devices as shown in FIG. 5. The size of the pocket in the rotating drum determines the quantity of salts being dispensed.

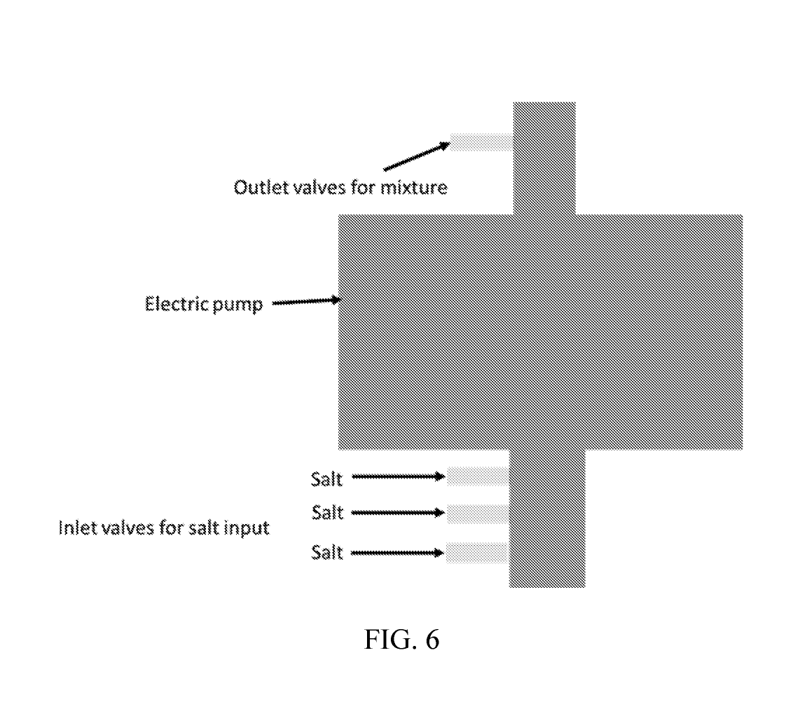

Third, using a liquid valve. Similar to a soda syrup dispenser, the system can use an electrically driven valve to dispense the liquid salt concentrate into the water. FIG. 6 shows one such example.

Depending on the variety of salts, each of the above methods will have to be repeated for each salt. Each dispenser in the system will have the capability of individually storing or combining, at least, the following salts: calcium chloride, magnesium chloride, potassium bicarbonate, potassium carbonate, sodium bicarbonate, dipotassium phosphate, magnesium sulfate, silica, sodium, electrolytes, fluoride, other sulfates, and other carbonates.

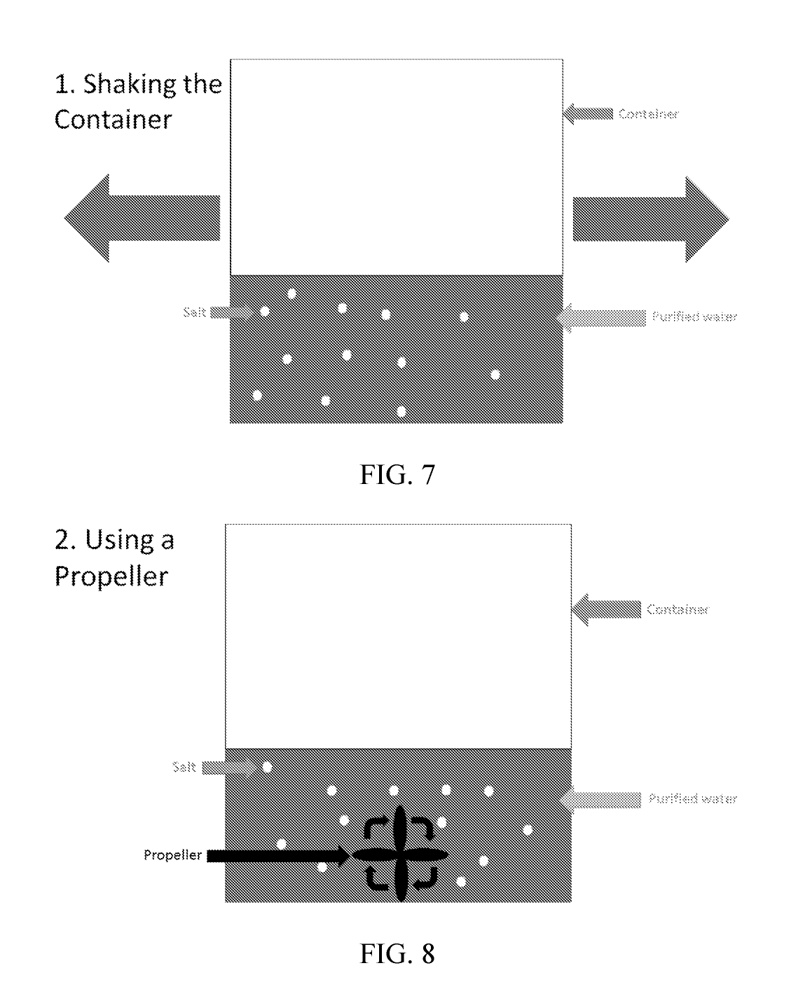

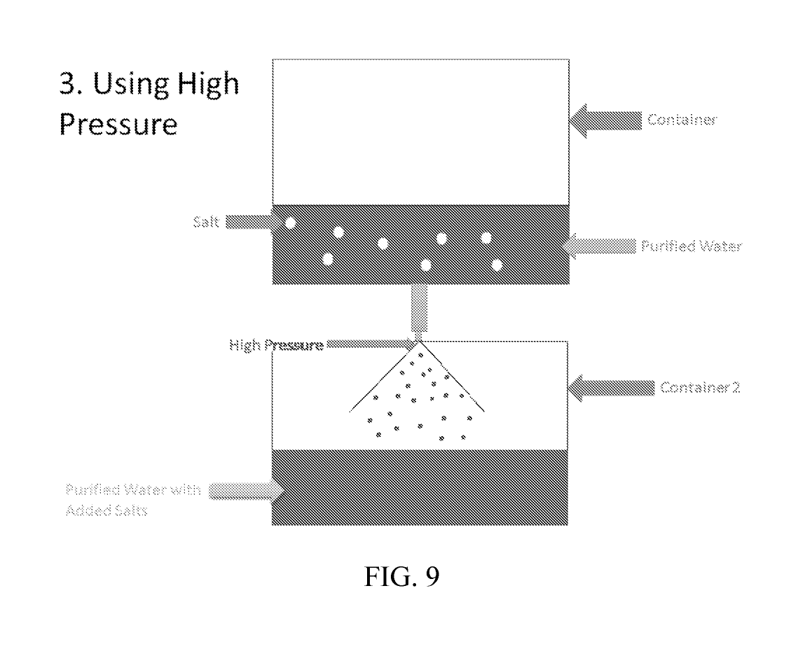

As illustrated in FIGS. 7 through 9, once the correct concentrations of salts for the particular formulation selected have been added to the water, the system will then agitate the mixture to speed up the dissolution process. The system can agitate the mixture in several different ways: by shaking the container, as shown in FIG. 7, by using a propeller, as shown in FIG. 8, by using a small orifice to push the mixture at high pressure, as shown in FIG. 9, or by heating the water.

Shaking the container aids in mixing the salts and minerals into the water in a conventional way. Using a propeller forces the solution to spin in a circular rotation to mix the minerals and salts into the water. Forcing the solution through a small orifice at high pressure aids in mixing without the need for rotating parts. The minerals and salts may be dissolved by heating the water, or by heating and then cooling the water. All of these methods can be applied to the container where the water is being dispensed or they can be applied in the inner chamber where the mixing is performed

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A personal water enhancement device, comprising:
a water filter;
a salt dispenser; and
a mixer;
wherein said water filter may extract a plurality of impurities from a volume of water;
wherein said salt dispenser may add a plurality of salts to a volume of water; and
wherein said mixer may ensure said plurality of salts are adequately dissolved in said volume of water.

2. The invention of claim 1, further comprising:
a salt container;
wherein said salt container may store said plurality of salts within the device.

3. The invention of claim 2, further comprising:
a database of water formulations;
wherein said database of water formulations may include a plurality of preset water formulations.

4. The invention of claim 3,
wherein said database of water formulations may include a plurality of user-defined water formulations.

5. The invention of claim 4, further comprising:
a user interface.

6. The invention of claim 5,
wherein said user interface comprises a touch screen interface.

7. The invention of claim 6,
wherein said user interface comprises an interface for a hearing-impaired user.

8. The invention of claim 7,
wherein said user interface comprises an interface for a visually-impaired user.

9. The invention of claim 8,
wherein the device is installed in a refrigerator.

10. A personal water enhancement device, comprising:
a water filter; and
a salt dispenser;
wherein said water filter may extract a plurality of impurities from a volume of water; and
wherein said salt dispenser may add a plurality of salts to a volume of water.

11. The invention of claim 10, further comprising:
a salt container;
wherein said salt container may store said plurality of salts within the device.

12. The invention of claim 11, further comprising:
a database of water formulations;
wherein said database of water formulations may include a plurality of preset water formulations.

13. The invention of claim 12,
wherein said database of water formulations may include a plurality of user-defined water formulations.

14. The invention of claim 13, further comprising:
a user interface.

15. The invention of claim 14,
wherein said user interface comprises a touch screen interface.

16. The invention of claim 15,
wherein said user interface comprises an interface for a hearing-impaired user.

17. The invention of claim 16,
wherein said user interface comprises an interface for a visually-impaired user.

18. The invention of claim 17,
wherein the device is installed in a refrigerator.
